(19) United States
(12) Patent Application Publication
(10) Pub. No.: US 2020/0071622 A1
(43) Pub. Date: Mar. 5, 2020

(54) Passivation and Removal of Crosslinked Polymer Having Unites Derived from Vinyl Aromatics

(71) Applicant: ExxonMobil Chemical Patents Inc., Baytown, TX (US)

(72) Inventors: Monica Malhotra, Singapore (SG); Michael Moran, Houston, TX (US); Kuldeep Wadhwa, Singapore (SG); Renyuan Yu, Humble, TX (US); Neeraj Sangar, League City, TX (US)

(21) Appl. No.: 16/552,541

(22) Filed: Aug. 27, 2019

Related U.S. Application Data
(60) Provisional application No. 62/725,600, filed on Aug. 31, 2018.

(51) Int. Cl. C10G 9/16; C10G 75/00; B08B 9/08

(52) U.S. Cl. CPC C10G 9/16; B08B 9/08; C10G 75/00

(57) ABSTRACT

Methods are provided for passivating and/or solubilizing crosslinked popcorn polymer formed from vinyl aromatic precursors. The passivation and/or solubilization can be performed by exposing the crosslinked popcorn polymer to an aromatics-containing solvent at a suitable temperature and/or by heat treating the crosslinked popcorn polymer in the presence of steam and oxygen followed by exposure to an aromatics-containing solvent. The vinyl aromatic polymer can be exposed to the aromatics-containing solvent for a suitable period of time at a temperature of 200° C. or more. Optionally, the aromatics-containing solvent can be at least partially in the liquid phase during the exposure of the vinyl aromatic polymer.

### PRIORITY

This application claims priority to and the benefit of U.S. Provisional Application No. 62/725,600, filed Aug. 31, 2018, the disclosure of which is incorporated herein by reference in its entirety.

### FIELD

Systems and methods are provided for passivating and/or removing crosslinked polymer having units derived from vinyl aromatics.

### BACKGROUND

Vinyl aromatics can be present in petroleum processing equipment in a variety of settings. Vinyl aromatics such as styrene are commercially valuable feeds for a variety of chemical production processes. This demand for vinyl aromatics is typically satisfied in part based on commercial production processes for forming vinyl aromatics. Additionally, vinyl aromatic streams are often purified to improve operation of processes that use vinyl aromatics as a feedstock and/or to improve the quality of the resulting products from such processes. Still other processes that can involve vinyl aromatics are pyrolysis processes such as steam cracking, where vinyl aromatics can be formed in the pyrolysis environment.

One of the difficulties with vinyl aromatic production processes, vinyl aromatic purification processes, and/or other processes where vinyl aromatics are present in the reaction environment is the formation of polymers as a side product, e.g., polymers having units (or segments) derived from vinyl aromatics. Such polymers include those commonly referred to as “popcorn” polymer, which corresponds to a porous three-dimensional structure that can rapidly grow under conditions present in various vinyl aromatic production/purification/polymerization processes. Once popcorn polymer growth is initiated due to the presence of oxygen or another initiator, the polymer growth process can correspond to a proliferous growth process that results in formation of “seeds” which can allow continued popcorn polymer growth even after the initiator is removed from the environment. The growth of popcorn polymer on various surfaces within process equipment can shorten run lengths. Under some conditions, the growth rate of the popcorn polymer can become exponential, possibly posing a risk of breaking open process equipment due to excessive pressure. It is noted that substances referred to as “popcorn polymer” can also be formed by other olefin-containing compounds, but the properties popcorn polymers formed from different monomers may vary. Popcorn polymer that is crosslinked (e.g., polymer containing a chain and/or chain segment that is chemically and/or physically bound to or entangled with at least one other polymer chain) is particularly troublesome from a processing perspective.

Some conventional methods for reducing or minimizing difficulties due to popcorn polymer, such as crosslinked popcorn polymer, are related to using inhibitors to prevent formation of the popcorn polymer. One example of an inhibition process for preventing popcorn polymer growth is provided in U.S. Pat. No. 4,956,020. In the inhibition process, the interior of processing equipment is exposed to a solution containing 0.5 wt. % to 10 wt. % of one of a variety of compounds, such as nitrogen-containing aromatic compounds. The solvent corresponds to water or a water soluble organic solvent such as an alcohol or a mineral oil. The interior of the processing equipment is exposed to the solution for a suitable period of time, such as 24 hours. An example of the process indicates that 60° C. is a suitable temperature for exposing the interior of the processing equipment to the solution. The examples show that for olefins such as styrene, growth of popcorn polymer is reduced or minimized after exposure to the solution. It is noted that exposing the interior of the processing equipment to xylene under similar conditions is provided as a comparative example, where little or no reduction in popcorn polymer growth was observed after exposure of the interior of processing equipment to the xylene.

U.S. Pat. No. 5,420,239 describes methods for inhibition of popcorn polymer by heat treatment in the absence of the type of olefin-containing compounds that can result in growth of the popcorn polymer. Temperatures of 60° C. to 650° C. are described, with temperatures between 120° C. and 430° C. being preferred and temperatures greater than 260° C. being more preferred.

In addition to difficulties with inhibiting growth of popcorn polymer, removing popcorn polymer from a system can also pose difficulties, particularly for crosslinked polymer. Although an inhibitor may work to prevent polymer growth for a period of time, under the proper conditions the existing popcorn polymer may become reactivated, leading to further polymer growth. For example, heating the interior environment of processing equipment to temperatures of 120° C. or more may be sufficient to reactivate seed locations within a popcorn polymer deposit. Even if existing popcorn polymer growth sites are passivated and do not reactivate, additional sites can form, which can still result in undesirable accumulation of polymer over time on interior surfaces of a system. Thus, what is needed are systems and methods that can both passivate popcorn polymer within a system as well as solubilize at least a portion of the popcorn polymer to allow for removal.

Butadiene is another example of an olefin-containing compound that can cause popcorn polymer formation (including crosslinked polymer), such as during production and/or purification of butadiene in a butadiene reaction system. India patent document 2609 mum 2015 describes a process for on-site cleaning of an apparatus to remove popcorn polymer formed from butadiene monomers. In the process, popcorn polymer deposits formed from butadiene are exposed to a cleaning fluid composed of tri-octyl ammonium chloride at 30° C.-90° C. The cleaning fluid is maintained and/or flowed through the apparatus containing the popcorn polymer deposits for 6-12 hours with agitation or turbulence.

U.S. Pat. No. 3,426,091 discloses removing polymer deposits formed during polystyrene manufacturing by contacting the deposits with an air-steam mixture at a temperature in the range of 180° C. to 270° C., to decompose or degrade the polymer. The residue of this treatment is removed by a solvent suitable for dissolving polystyrene, e.g., styrene monomer, benzene, toluene, xylene, ethylbenzene—all of which have a normal boiling point ≤148° C. Similarly, U.S. Patent Application Publication No. US2003/0073595A1 discloses removing foulant from equipment used for manufacturing olefinic polymers (e.g., polystyrene) and copolymers by contacting the foulant with a high-boiling aromatic solvent having a boiling point above about 93° C. U.S. Patent Application Publication No. US2012/0174948A1 discloses removing crosslinked polymeric fouling by contacting the foulant with a mixture of aromatic solvent and non-aromatic solvent.

Improved systems and methods are desired for removal of crosslinked polymer deposits, such as popcorn polymer deposits, e.g., those formed based on polymerization of vinyl aromatic compounds. Additionally, it would be desirable for such an improved method to occur in-situ, so that removal of the crosslinked polymer does not require transport of equipment to an off-site location for cleaning.

### SUMMARY

In various aspects, methods are provided for passivating and/or solubilizing crosslinked polymer, such as popcorn polymer, formed from vinyl aromatic precursors. The passivation and/or solubilization can be performed by exposing the crosslinked vinyl aromatic polymer to an aromatics-containing solvent at a suitable temperature and/or by heat treating the vinyl aromatic popcorn polymer in the presence of steam and oxygen followed by exposure to an aromatics-containing solvent. Unexpectedly, in view of the teachings of the prior art, non-aromatic solvent is not needed to remove the crosslinked polymeric foulant. Instead, the polymer can be exposed to the aromatics-containing solvent for a suitable period of time at a temperature of 200° C. or more. Optionally, the aromatics-containing solvent can be at least partially in the liquid phase during the exposure of the crosslinked vinyl aromatic polymer.

Exposing the crosslinked vinyl aromatic polymer to an aromatics-containing solvent at a temperature of 200° C. or more can allow for solubilization of at least a portion of the polymer that has been deposited in a processing environment, such as solubilization of substantially all of the deposited polymer. Typically, the aromatics-containing solvent comprises ≥90 wt. % of aromatics having a normal boiling point ≥150° C., e.g., ≥95 wt. %, such as ≥99 wt. %; with ≤0.1 wt. % of the remainder comprising non-aromatics, e.g., ≤0.01 wt. %, such as ≤0.01 wt. %. Surprisingly, since crosslinked polymer is more resistant solubilization than are non-crosslinked chains of similar composition, it has been found that performing an initial heat treatment (e.g., one carried out in the presence of air and/or steam) can potentially allow lower boiling aromatics, such as toluene, to be used as the aromatics-containing solvent.

### BRIEF DESCRIPTION OF THE DRAWINGS

FIG. 1 shows results for solubilization of vinyl aromatic polymer deposits after heat soaking in the presence of a various aromatics-containing solvents.

FIG. 2 shows results for volatilization and solubilization of vinyl aromatic polymer deposits after various heat treatments in the presence of steam and oxygen.

FIG. 3 shows an example of a processing train for processing a steam cracked effluent.

### DETAILED DESCRIPTION

All numerical values within the detailed description and the claims herein are modified by “about” or “approximately” the indicated value, and take into account experimental error and variations that would be expected by a person having ordinary skill in the art.

Aspects of the invention will now be described in more detail where the crosslinked polymer is a crosslinked popcorn polymer having units derived from vinyl aromatics (“vinyl aromatic polymer). The invention is not limited to these aspects, and this description should not be interpreted as foreclosing other forms of crosslinked polymer within the broader scope of the invention. In various aspects, methods are provided for passivating and/or solubilizing crosslinked popcorn polymer formed from vinyl aromatic precursors by exposing the crosslinked popcorn polymer to an aromatics-containing solvent. Typically, the crosslinked popcorn polymer is subject to a thermal treatment during at least part of the time period in which the aromatics-containing solvent is in the presence of (and typically in contact with) the crosslinked popcorn polymer. The thermal treatment includes maintaining the crosslinked popcorn polymer at a temperature ≥150° C. for a thermal treatment time ≥1 hour. Although the aromatics-containing solvent can be in the presence of (and typically in contact with) the crosslinked popcorn polymer during the entire thermal treatment time, this is not required. In certain aspects, the aromatics-containing solvent is in the presence of (and typically in contact with) the crosslinked popcorn polymer during ≥10% of the thermal treatment time, e.g., ≥25%, such as ≥50%, or ≥75%, or ≥90%. Likewise, the aromatics-containing solvent can optionally be in the presence of (and typically in contact with) the crosslinked popcorn polymer before and/or after the thermal treatment, e.g., for a time that is a multiple M of the thermal treatment time. For example, M can be in the range of from 0.01 to 100, e.g., from 0.1 to 10. When the crosslinked popcorn polymer is maintained at a substantially constant temperature during the thermal treatment (e.g., within a temperature range of +/−10° C., such as +/−1° C.), the thermal treatment is referred to as a “heat soak”. Typically, the vinyl aromatic polymer and the aromatics-containing solvent are maintained at substantially the same temperature during the heat soak, although this is not required. For example, during the heat soak (e.g., during the thermal treatment time) the crosslinked polymer and the aromatics-containing solvent can be maintained at a temperature of 200° C. or more, or 220° C. or more, or 240° C. or more, or 260° C. or more, such as up to 350° C. or possibly still higher. Temperatures ≥200° C. are typically desired, although the heat soak temperature should be regulated to not exceed a temperature at which the crosslinked popcorn polymer would convert to more difficult to remove species such as coke. Typically, the crosslinked popcorn polymer is exposed to the aromatics-containing solvent at the heat soaking temperature for a thermal treatment time (a heat soak time in this case) in the range of from 12 hours to 150 hours, or 24 hours to 120 hours, or 48 hours to 150 hours, or 96 hours to 150 hours. At any time before, during, and/or after the heat soak, the aromatics-containing solvent can be brought into contact with the crosslinked popcorn polymer at any convenient pressure from ambient pressure (0 gauge) to 25 MPa-g or possibly still higher. Typically, deposited crosslinked popcorn polymer is exposed to (typically is in direct contact with) the aromatics-containing solvent during the heat soak at a pressure of 0 MPa-g to 25 MPa-g, or 0.1 MPa-g to 25 MPa-g, or 5.0 MPa-g to 25 MPa-g, or 10 MPa-g to 25 MPa-g. The crosslinked popcorn polymer can be exposed to the aromatics-containing solvent by introducing the aromatics-containing solvent into the processing equipment or system that contains the crosslinked popcorn polymer formed from the vinyl aromatic precursors. Optionally, the aromatics-containing solvent can be at least partially in the liquid phase during the exposure to the crosslinked popcorn polymer.

Additionally or alternately, in various aspects, methods are provided for passivating and/or solubilizing crosslinked popcorn polymer formed from vinyl aromatic precursors by heat treating the crosslinked popcorn polymer in the presence of steam and oxygen followed by exposing the heat treated crosslinked popcorn polymer to a solvent. In addition to the solvents noted above, a lower boiling aromatic solvent such as toluene can be used to solvate the heat-treated popcorn polymer. The heat treatment can include exposing the crosslinked popcorn polymer to a gas phase environment including steam and 0.5 wt. % to 5.0 wt. % O₂. The heat treatment can include exposing the crosslinked popcorn polymer to the gas phase environment at a temperature of 220° C. or more, or 240° C. or more, or 260° C. or more, such as up to 350° C. or possibly still higher. The crosslinked popcorn polymer can be exposed to the gas phase environment for a period of 12 hours to 150 hours, or 24 hours to 120 hours, or 48 hours to 150 hours, or 96 hours to 150 hours prior to exposing the heat-treated polymer to a solvent.

The solubilization and heat treatment processes described herein can generally be referred to as methods for exposing crosslinked popcorn polymer deposits to a solubility-enhancing environment. Exposing the vinyl aromatic polymer deposits to the solubility-enhancing environment can result in heat-treated polymer deposits with enhanced solubility, so that the heat-treated deposits are at least partially removable in the presence of an aromatic solvent.

Examples of processing equipment and/or systems that can have crosslinked popcorn polymer deposits on surfaces within the equipment include, but are not limited to, reactors, heat exchangers, conduits, heaters, distillation towers, and/or any other convenient type of processing equipment that is used in preparation, purification, or polymerization of vinyl aromatic monomers. As an example, one type of process that can generate vinyl aromatics is steam cracking. The vinyl aromatics generated during a steam cracking process can potentially cause fouling within downstream processing equipment, such as the primary fractionator, the (steam cracker) tar knockout drum, or other downstream equipment. Contrary to the teachings of the prior art it has been found that crosslinked polymer such as crosslinked polymer foulant accumulating on or in steam cracking process equipment (e.g., in the primary fractionator and/or tar knockout drum) can be effectively removed using a solvent that contains ≤0.1 wt. % of non-aromatics, e.g., a solvent that is substantially free of aromatics.

In this discussion, a vinyl aromatic monomer or precursor can correspond to any suitable type of monomer that includes both an olefin group and an aromatic group, such as styrenes. A crosslinked popcorn polymer corresponds to a polymer formed at least in part from vinyl aromatic monomers, such as a polymer where 50 wt. % or more of the polymer corresponds to vinyl aromatic monomers, or 75 wt. % or more, or 90 wt. % or more, such as up to substantially all of the polymer being composed of vinyl aromatic monomers.

Examples of suitable aromatics-containing solvents, can include, but are not limited to, single component aromatic solvents having a suitable boiling range and multi-component aromatic solvents having a suitable boiling range. Preferably, the aromatics-containing solvent can be substantially free (i.e., containing 0.1 wt. % or less) of vinyl aromatic compounds. Optionally, the aromatics-containing solvent can include 1.0 wt. % or less, or 0.1 wt. % or less, of olefin-containing compounds. Although the aromatics-containing solvent can include non-aromatic components, typically the aromatics-containing solvent includes 0.1 wt. % or less, or 0.01 wt. % or less, of non-aromatics. Suitable aromatic solvents can include, but are not limited to aromatic compounds having a normal boiling point (at roughly 1 atm or roughly 100 kPa-a) of 120° C. or more, or 150° C. or more, or 200° C. or more, such as up to 500° C. or possibly still higher. Examples of suitable solvents include single ring aromatic compounds such as xylenes, multi-ring aromatics such as naphthalene, naphthenoaromatics such as tetralin, and mixtures of aromatics, such as various commercially available aromatic fluids. Examples of suitable commercially available aromatic fluids include the Solvesso™ aromatic fluids available from Exxon Mobil Corporation. Still other suitable aromatics-containing solvents can correspond to various refinery or chemical streams, such as quench oils, aromatic crude fractions, or other refinery streams having a sufficient aromatic content. When a thermal treatment of the crosslinked polymer is not carried out before the specified solvent treatment, the aromatic solvent should be one having a normal boiling point of 150° C. or more, or 160° C. or more, or 180° C. or more, or 230° C. or more, or 245° C. or more. In these aspects, for example, one or more of Solvesso™ 100, Solvesso™ 150, and Solvesso™ 200 can be used.

The portion of the aromatics-containing solvent corresponding to aromatics having a boiling point of 120° C. or more (or 150° C. or more, or 200° C. or more) can correspond to 40 wt. % or more of the aromatics-containing solvent, or 60 wt. % or more, or 80 wt. % or more, such as up to substantially all of the aromatics-containing solvent. In some alternative aspects, e.g., those where a thermal treatment is used before the solvent treatment, a solvent containing less than 40 wt. % of an aromatics-containing solvent may also be suitable for solubilization of the crosslinked popcorn polymer in conjunction with heating at 260° C. or higher. For example, a mixture of aromatic solvent and paraffinic solvent having a sufficiently high average molecular weight may potentially be suitable. In certain aspects, e.g., those where a thermal treatment is not used before the solvent treatment, the portion of the aromatics-containing solvent corresponding to aromatics having a boiling point of 150° C. or more, or 160° C. or more, or 180° C. or more, or 230° C. or more, or 245° C. or more can correspond to 40 wt. % or more of the aromatics-containing solvent, or 60 wt. % or more, or 80 wt. % or more, such as up to substantially all of the aromatics-containing solvent.

In aspects wherein the crosslinked popcorn polymer is thermally treated (e.g., heat treated), such as a heat treatment in the presence of steam and 0.5 wt. % to 5.0 wt. % oxygen, the amount of steam can be any convenient amount that facilitates providing a desired temperature for the heat treatment, such as 1.0 wt. % to 99 wt. %. Preferably, the amount of steam can be greater than the amount of O₂. Optionally, the gas phase environment can further include an inhibitor for crosslinked popcorn polymer formation, such as any of the commercially known inhibitor compounds. The balance of the environment can correspond to nitrogen or another convenient inert gas. Preferably, the gas phase environment can be substantially free (0.1 wt. % or less, or 0.01 wt. % or less) of vinyl aromatic compounds. Optionally, the gas phase environment can include 1.0 wt. % or less, or 0.1 wt. % or less, of olefin-containing compounds.

In aspects where the crosslinked popcorn polymer is heat treated in the presence of steam and oxygen prior to exposure to the aromatics-containing solvent, the aromatics-containing solvent can include lower boiling aromatic compounds. In such aspects, the aromatics-containing solvent can include 40 wt. % or more (or 60 wt. % or more, or 80 wt. % or more) of aromatics having a boiling point of 100° C. or more, or 120° C. or more, or 150° C. or more. This can allow, for example, toluene to correspond to the aromatic compound (or one of the aromatic compounds) in the aromatics-containing solvent.

Aspects of the invention relating to heat soaking crosslinked popcorn polymer deposits in the presence of an aromatics-containing solvent will now be described in more detail with reference to the following examples. The invention is not limited to these aspects, and the following description is not meant to foreclose the use of other forms of thermal treatment and solvent-contacting within the broader scope of the invention.

### EXAMPLE 1

### Heat Soaking in an Aromatics-Containing Solvent

Various aromatics-containing solvents were investigated to determine the effectiveness of the solvents for solubilization and removal of the crosslinked popcorn polymer deposits. For each test, an initial weight of crosslinked popcorn polymer formed from vinyl aromatic monomers (styrene) was formed within a reaction vessel. The reaction vessel corresponded to a stainless steel flow-through reactor. After forming the polymer deposits, an aromatics-containing solvent was introduced into the reaction vessel and circulated at a temperature of ˜220° C. for a period of time ranging from 12 hours to 120 hours. The heat soaking was performed at a pressure of roughly 100 kPa. After the time period, the aromatics-containing solvent was drained from the reaction vessel. The reaction vessel was weighed after polymer formation and again after removal of the solvent to determine the weight of polymer removed. This allowed for a determination of the weight percentage of polymer that was solubilized (i.e., removed) by the heat soaking in the aromatics-containing solvent.

Two of the solvents tested were single component aromatic solvents, corresponding to a mixture of xylenes (boiling point ˜140° C.) and tetralin (boiling point ˜208° C.). The third solvent corresponded to a Solvesso™ A10 aromatic fluid, which has an initial boiling point of roughly 150° C. The fourth solvent corresponded to a quench oil (“QO”) derived from a fluid catalytic cracking light cycle oil. It is noted that at least a portion of the quench oil were in the liquid phase during the heat soaking.

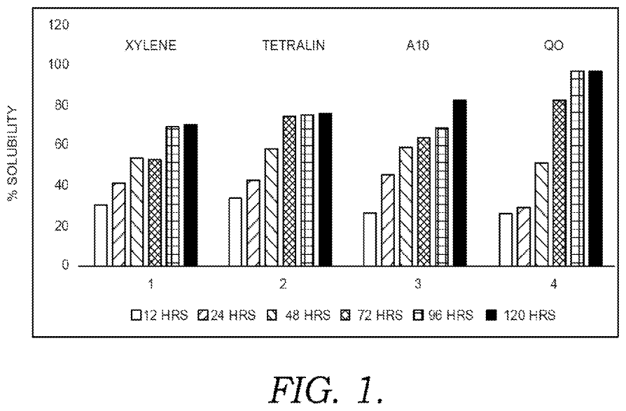

FIG. 1 shows results from exposing the crosslinked popcorn polymer to the various solvents with various time lengths for the heat soaking. As shown in FIG. 1, the effectiveness of the aromatics-containing solvent for removing the polymer deposits increased with increasing exposure (heat-soaking) time. For example, FIG. 1 appears to show that exposure of the polymer deposits to the aromatics-containing solvent for a period of 96 hours or more resulted in the highest effectiveness for removal of the polymer. In particular, xylene was effective for removal of roughly 30 wt. % of polymer deposits after 12 hours, and up to 70 wt. % of polymer deposits after 96 hours or 120 hours. The tetralin had somewhat higher removal effectiveness of 75 wt. % to 80 wt. % after 96 hours or 120 hours. The A10 aromatic fluid had effectiveness that was intermediate to the xylene and the tetralin. All of the solvents were also somewhat effective for polymer removal at shorter run lengths, with 25 wt. % to 30 wt. % of the polymer deposits being removed after only 12 hours of exposure to the various solvents.

As noted above, at least a portion of the quench oil was in the liquid phase during the heat soaking. At shorter lengths of heat soaking, it appeared that the substantial liquid phase was not beneficial. At time periods of 48 hours or less, the quench oil solubilized less of the polymer deposits than any of the other solvents. However, for time periods of 72 hours or more, the quench oil unexpectedly provided higher levels of polymer removal than any of the other solvents. Additionally, for time periods of 96 hours or more, the quench oil provided substantially complete removal of polymer deposits. Without being bound by any particular theory, it is believed that the presence of a substantial liquid phase during heat soaking with the quench oil allowed for improved solubilization and/or removal of the crosslinked popcorn polymer for the longer heat soaking periods.

Without being bound by any particular theory, it is believed that heat soaking in the presence of an aromatics-containing solvent can allow crosslinked chains (e.g., polymers chains that are chemically and/or physically bound or entangled) with a crosslinked popcorn polymer deposit to be cleaved off and solubilized. Due to the aromatic nature of crosslinked popcorn polymer, a primarily aliphatic solvent can have a reduced or minimized effectiveness for “solubilizing” the crosslinked popcorn polymer and entering into the deposit. This can limit the ability of a non-aromatic solvent to effectively remove the crosslinked popcorn polymer deposits. By contrast, heat soaking at a temperature of 220° C. or more in the presence of an aromatics-containing solvent can allow for both breaking of cross-link bonds and/or other bonds within the polymer deposit as well as solubilization and removal of the smaller polymer fragments formed during the heat soaking.

### EXAMPLE 2

### Heating with Subsequent Exposure to Aromatic Solvent

A stainless steel flow-through reactor was used to test the effectiveness of various types of thermal treatments for removal of crosslinked popcorn polymer. The thermal treatments were performed in the presence of steam and optionally in the presence of oxygen. For each test, crosslinked popcorn polymer was formed within the reactor. Steam was then introduced into the reactor to increase the temperature over a period of 6 hours to a target temperature of 205° C. to 275° C. The target temperature was then maintained for roughly 48 hours, 72 hours, or 96 hours. In some tests, 0.5 wt. % to 5.0 wt. % of O₂ was included with the steam.

The reactor was weighed prior to and after the heat treatment to determine the amount of polymer that was volatilized during the heat treatment. After the heat treatment, the reactor was then cooled and toluene was refluxed through the reactor for ˜6 hours to remove any polymer that was soluble. The remaining material in the reactor was then characterized to determine if the remaining material corresponded to coke (hydrogen to carbon molar ratio of roughly 0.5-0.6) or crosslinked popcorn polymer (polystyrene, hydrogen to carbon molar ratio of roughly 1.0). The characterization of coke versus polymer was made using thermogravimetric analysis and by taking samples of the remaining material for characterization in a CHN analyzer.

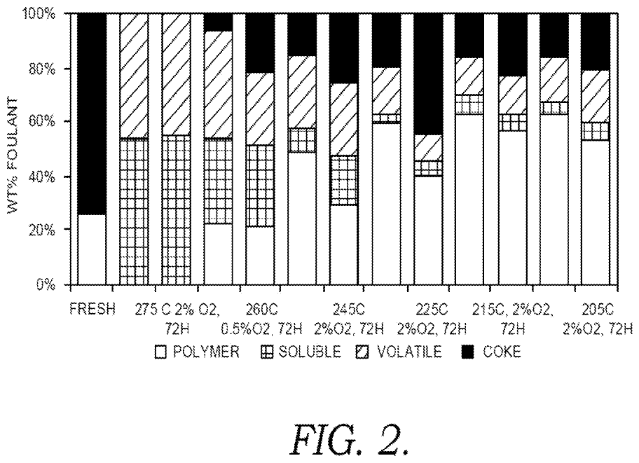

FIG. 2 shows results from exposing crosslinked popcorn polymer to various types of heat treatments for 72 hours. In FIG. 2, the first bar corresponds to “fresh” crosslinked popcorn polymer without subsequent heat treatment. As shown in FIG. 2, the “fresh” polymer deposits include some coke prior to any thermal treatment.

The remaining bars in FIG. 2 correspond to pairs of tests that were performed at each condition. For the pair of runs at 260° C., the heat treatment was performed using steam containing 0.5 wt. % O₂. For the remaining tests shown in FIG. 2, the heat treatment was performed using steam containing 2.0 wt. % O₂.

As shown in FIG. 2, all of the temperatures were effective for causing some removal of polymer as volatile compounds. However, at temperatures of 245° C. and lower, the amount removed as volatile compounds corresponded to roughly 5 wt. % to 20 wt. %. Another 10 wt. % or less of the polymer was also soluble in toluene after the heat treatments at 245° C. or less. This means that roughly 70 wt. % or more of the initial crosslinked popcorn polymer remained in the reactor in the form of either polymer or coke.

By contrast, the heat treatments at 260° C. and 275° C. were effective at removing a substantially greater portion of the crosslinked popcorn polymer deposits. This included both increased amounts of volatilization and increased amounts of polymer converted into soluble material. As shown in FIG. 2, only 30 wt. % to 40 wt. % of the initial polymer remained in the reactor in the form of coke or polymer after the heat treatment at 260° C. and the subsequent toluene wash. Increasing the temperature to 275° C. resulted in substantially complete removal of the initial polymer either as volatiles or as soluble compounds. Thus, a combination of heating at 260° C. or more, or 275° C. or more, in the presence of O₂ followed by solvent washing with an aromatics-containing solvent can be effective for substantially complete removal of crosslinked popcorn polymer deposits.

Aspects of the invention relating to removal of crosslinked popcorn polymer deposits from (and even lessening the occurrence in) steam cracker process equipment will now be described in more detail with reference to the following example. The invention is not limited to these aspects, and the following description is not meant to foreclose other forms of hydrocarbon process equipment within the broader scope of the invention as may be plagued by popcorn polymer accumulation.

### EXAMPLE 3

### Popcorn Polymer Removal in Steam Cracking Effluent Processing Train

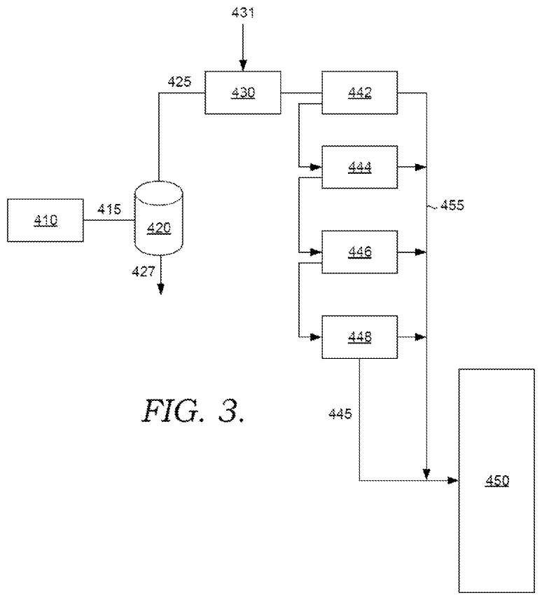

FIG. 3 shows a portion of the processing train for steam cracking. In FIG. 3, a steam cracking reactor 410 can generate an effluent 415 that is passed through a tar knockout drum 420. Tar knockout drum generates an overhead stream 425 and a steam cracked tar stream 427. The overhead stream 425 is then mixed 430 with quench oil 431 prior to passing the mixture through a series of quench coolers 442, 444, 446, and 448. Optionally, at least a portion of the quench oil 431 can be mixed with effluent 415 prior to passing into the tar knockout drum. The quench coolers can reduce the temperature of the mixture from roughly 300° C. to 150° C. prior to passing the quenched mixture 445 to a main fractionator 450. It is noted that as portions of the effluent and/or quench oil condense in each quench cooler, the condensed portions 455 are passed to the main fractionator directly. Only the remaining gas phase portion of the mixture is passed into the next quench cooler. In some aspects, more than one group of quench coolers 442, 444, 446, and 448 can be used to process a steam cracking reactor effluent. This can allow the quench coolers to match the capacity of the reactor and/or can allow for downtime in one group of quench coolers while other quench coolers remain on-line to allow continued operation of the steam cracker.

A system similar to the configuration shown in FIG. 3 was operated for a substantial period of time (more than one year). During operation, the exit temperature from quench cooler 442 was roughly 260° C., the exit temperature from quench cooler 444 was roughly 220° C., the exit temperature from quench cooler 446 was roughly 180° C., and the exit temperature from quench cooler 448 was roughly 150° C. Based on these exit temperatures, more than 90% of the quench oil was condensed out in quench cooler 442 and quench cooler 444. As a result, little or no quench oil remained in the mixture in quench cooler 446 and quench cooler 448. Additionally, the temperature in quench cooler 446 and quench cooler 448 was below 220° C.

After operation for the substantial period of time, processing was halted and the quench coolers were opened. No crosslinked popcorn polymer was observed in quench cooler 442 or quench cooler 444. A substantial amount of crosslinked popcorn polymer was observed in quench cooler 446. A lesser amount of crosslinked popcorn polymer was observed in quench cooler 448. Thus, when only minimal quench oil was present as a solvent, and at a temperature below 220° C., substantial crosslinked popcorn polymer was formed. By contrast, in quench coolers 442 and 444 where substantial amounts of liquid quench oil were present, no crosslinked popcorn polymer was observed.

One option for reducing, minimizing, or eliminating the crosslinked popcorn polymer in quench coolers 446 and 448 can be to periodically modify the operation of the quench coolers. For example, in aspects where multiple banks of quench coolers are available, a rotation can be set up so that one bank of quench coolers is periodically taken off-line. During such an off-line period, the temperature in quench coolers 446 and 448 can be increased to 220° C. or more while quench oil is passed through the quench coolers. This can allow at least a portion of any accumulated crosslinked popcorn polymer (such as substantially all) to be solubilized, allowing for removal.

When numerical lower limits and numerical upper limits are listed herein, ranges from any lower limit to any upper limit are contemplated. While the illustrative embodiments of the disclosure have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside in the present disclosure, including all features which would be treated as equivalents thereof by those skilled in the art to which the disclosure pertains.

The present disclosure has been described above with reference to numerous embodiments and specific examples. Many variations will suggest themselves to those skilled in this art in light of the above detailed description. All such obvious variations are within the full intended scope of the appended claims.

What is claimed is:

1. A method for treating crosslinked vinyl aromatic polymer deposits for passivation and solubility enhancement, comprising:
exposing crosslinked vinyl aromatic polymer deposited on one or more surfaces within a process vessel to a temperature of 220° C. or more in the presence of a solubility-enhancing environment to form heat-treated polymer deposits; and
exposing the heat-treated polymer deposits to a solvent containing aromatics to remove at least a solubilized portion of the heat-treated polymer deposits, the solubilized portion of the heat-treated polymer deposits corresponding to 40 wt. % or more of a weight of the crosslinked vinyl aromatic polymer.

2. The method of claim 1, wherein (i) exposing the crosslinked vinyl aromatic polymer to a temperature of 220° C. or more in the presence of a solubility-enhancing environment comprises exposing the crosslinked vinyl aromatic polymer to the temperature in a gas phase environment comprising 0.1 wt. % to 5.0 wt. % of O₂, and (ii) the solvent comprises ≥90 wt. % of aromatics and ≤0.1 wt. % of non-aromatics

3. The method of claim 2, wherein the temperature is 260° C. or more (or 275° C. or more).

4. The method of claim 2, wherein the gas phase environment comprises 0.5 wt. % to 5.0 wt. % O₂.

5. The method of claim 2, wherein the heat-treated polymer deposits are exposed to the aromatic solvent for 1.0 hours or more (or 5.0 hours or more).

6. The method of claim 2, wherein the heat-treated polymer deposits comprise 1.0 wt. % to 30 wt. % coke.

7. The method of claim 2, wherein the heat-treated polymer deposits are substantially free of coke.

8. The method of claim 2, wherein the aromatics-containing solvent comprises an initial boiling point at 100 kPa-a of 150° C.

9. The method of claim 1, wherein exposing the crosslinked vinyl aromatic polymer to a temperature of 220° C. or more in the presence of a solubility-enhancing environment comprises exposing the crosslinked vinyl aromatic polymer to the temperature in the presence of the aromatics-containing solvent.

10. The method of claim 9, wherein exposing the crosslinked vinyl aromatic polymer to the temperature in the presence of the aromatics-containing solvent comprises exposing the crosslinked vinyl aromatic polymer to the temperature in the presence of the aromatics-containing solvent in the liquid phase.

11. The method of claim 9, wherein the crosslinked vinyl aromatic polymer is exposed to the aromatics-containing solvent at a pressure of 5 MPa-g or more.

12. The method of claim 1, wherein the aromatics-containing solvent comprises an initial boiling point at 100 kPa-a of 230° C. or more.

13. The method of claim 1, wherein the aromatics-containing solvent comprises 40 wt. % or more of aromatics having a boiling point at 100 kPa-a of 120° C. or more.

14. The method of claim 1, wherein the crosslinked vinyl aromatic polymer is exposed to the temperature in the presence of the solubility-enhancing environment for 24 hours or more.

15. The method of claim 1, wherein the aromatics-containing solvent comprises toluene, xylene, tetralin, or a combination thereof.

16. The method of claim 1, wherein exposing the heat-treated polymer deposits to an aromatics-containing solvent comprises removing 60 wt. % or more of the heat-treated polymer deposits based on the weight of the crosslinked vinyl aromatic polymer (or 80 wt. % or more, or 95 wt. % or more).

17. The method of claim 1, wherein the solubilized portion of the heat-treated polymer deposits comprises 60 wt. % or more of the weight of the crosslinked vinyl aromatic polymer (or 80 wt. % or more).

18. A method for treating crosslinked vinyl aromatic polymer deposits for passivation and solubility enhancement, comprising:
exposing crosslinked vinyl aromatic polymer deposited on one or more surfaces within a process vessel to a temperature of 220° C. or more in the presence of an aromatics-containing solvent in the liquid phase to solubilize at least a portion of the deposited polymer, the solubilized portion of the deposited polymer corresponding to 40 wt. % or more of a weight of the deposited polymer.

19. The method of claim 18, wherein the aromatics-containing solvent comprises an initial boiling point at 100 kPa-a of 120° C. or more.

20. The method of claim 18, wherein the aromatics-containing solvent comprises 40 wt. % or more of aromatics having a boiling point at 100 kPa-a of 120° C. or more.

21. The method of claim 18, wherein the crosslinked vinyl aromatic polymer is exposed to the aromatics-containing solvent for 24 hours or more.

22. The method of claim 18, wherein the aromatic solvent comprises toluene, xylene, tetralin, or a combination thereof.

23. The method of claim 18, wherein exposing the deposited polymer to an aromatics-containing solvent comprises solubilizing 60 wt. % or more of the deposited polymer based on the weight of the deposited polymer.

24. The method of claim 18, wherein the crosslinked vinyl aromatic polymer is exposed to the aromatics-containing solvent at a pressure of 5 MPa-g or more.

25. The method of claim 18, wherein the process vessel comprises a quench cooler, or wherein the process vessel comprises a process vessel for processing a steam cracking effluent, or a combination thereof.

26. A method for removing polymer deposits from steam cracking equipment, the process comprising:
carrying out a solvent treatment, wherein (i) the solvent treatment includes exposing the polymer deposits to a solvent to remove at least a solubilized portion of the polymer deposits and (ii) the solvent comprises ≥90 wt. % of aromatics having a normal boiling point ≥120° C. and ≤0.1 wt. % of non-aromatics.

27. The method of claim 26, further comprising carrying out a thermal treatment before the solvent treatment, wherein the thermal treatment includes exposing the polymer deposits to a temperature of 220° C. or more in the presence of a solubility-enhancing environment.

28. The method of claim 26, wherein (i) the solvent treatment is not preceded by a thermal treatment, and (ii) the solvent comprises ≥95 wt. % of aromatics having a normal boiling point ≥150° C. and ≤0.01 wt. % of non-aromatics.
